(19) United States
(12) Patent Application Publication
(10) Pub. No.: US 2003/0158923 A1
(43) Pub. Date: Aug. 21, 2003

(54) System and method for automated negotiation for and allocation of a broadcast satellite, communication and caching system resource

(76) Inventor: Reed Burkhart, Walnut Creek, CA (US)

Correspondence Address: James S. Hsue, SKJERVEN MORRILL MacPHERSON LLP, Suite 2800, 3 Embarcadero Center, San Francisco, CA, 94111, US

(21) Appl. No.: 09/847,590

(22) Filed: May 2, 2001

Related U.S. Application Data
(60) Provisional application No. 60/202,369, filed on May 4, 2000.

(51) Int. Cl. G06F 15/173

(52) U.S. Cl. 709/223

(57) ABSTRACT

A system and method is presented for automated negotiation for and allocation of a broadcast satellite, communication, and caching system resource, involving establishing rules for use of the system by both programmers or content contributors and viewers or content recipients, such rules being implemented for processing throughout the system according to the applicability of the rules to that part of the system, with centralized and decentralized command and reporting.

### CROSS REFERENCE TO RELATED APPLICATION

This application is a continuation of U.S. Provisional Application Serial No. 60/202,368, filed May 4, 2000, which is incorporated herein by reference in its entirety.

### BACKGROUND OF THE INVENTION

Sweet spots of satellites, computers, and caches. The preferential use of satellites is for broadcasting, a use that is highly leveraged since an arbitrarily large number of receivers can be attached to a simple satellite broadcast system—which, of course, is why broadcasting is the preferential use for satellites. The preferential uses of computers include automation of all sorts, such as for computation, transactions, data collection and storage, automated command and control, signal processing; representing a wide range of processes that can be set out in advance and managed semi-autonomously or autonomously by a computer or computers—which again, or course, is why automation is the preferential use of computers. The preferential use of computer caches is for managing the flow of information as a buffer; short-, medium-, or long-term repository again what caches are good at doing.

Network sweet spots range according to aggregate methods of implementation. The preferential use of the Internet, a medium utilizing satellites and other communications systems, computers, and caches, is manifold but primarily automation at a distance. The application may involving pushing or pulling of information, may involve one source and many destinations, many sources and one destination or one source and one destination. One of a number of transmission protocols may be used to affect the reliable and speedy delivery of signals over the network; and any of a number of processes may take place on the computers governing or governed by the signals transiting the network.

Deficiencies of internet addressed by present invention. Certain limitations of the Internet in its current form are addressed by the present invention, such as a deficiency in the bandwidth of the first or last segment of communications (when the content is popular), a deficiency in distributed or on-premise caching at various points, a deficiency in economy and the ability to provision and plan for the provisioning of non-broadcast-based multicast (i.e. multicast that takes place over a network of independent point-to-point links) since multicast is potentially a heavy bandwidth load that can go anywhere in the network with high levels of duplication across multiple transmission links.

### SUMMARY OF THE INVENTION

Introductory considerations regarding areas of unrealized potential involving leveraging disparate communications and storage tools, especially satellites in the Internet paradigm. Integrated systems involving satellites, computers, caches and other specialized equipment (such as transmission, multiplexing, receiving, etc.) would promise to offer the best attributes of each to enable the efficient delivery of popular content to numerous destinations, including caches for subsequent retrieval. The increasing popularity of the Internet has likewise increased the amount of content that is of interest to a wide variety of recipients (to the degree that there is common interest among Internet users). However, a major deficiency of any satellite Internet multicasting system today is that access to the system is still programmed in one or another fashion precluding the greater universe of prospective content distributors from gaining access to the system. One of the more recent and creative programming methods is a dynamic one in which popular content is measured on the Internet and the most popular content is introduced into the satellite multicasting system; but this doesn't go far enough in enabling an arbitrary user—at some price—to gain access to the broadcast satellite, communication or caching system resource but rather leaves the system programming control essentially in the hands of a single entity who sets up the monitoring locations and popularity threshold. This deficiency in providing widespread access is largely because the traditional methods for allocating satellite capacity are manual processes, with little in common with the decentralized way that content finds its way on to the Internet; while also reflecting satellites' higher cost than terrestrial point-to-point transmissions. Another consideration for efficient use of satellites is a significantly higher efficiency in their use when all of the signals to be sent through a satellite's individual repeating unit (a transponder) are multiplexed together into a single coherent bit-stream; such centralization being at odds with the decentralized nature of Internet traffic flow control methodologies.

Manual vs. automated provisioning, and aggregated cost-justification. The traditional manual processes used to provision satellite bandwidth have limited the range of applications of satellites to those with sufficiently high value for which the practitioners of the application are willing to dedicate the requisite resources for acquiring full-time or occasional satellite capacity through a broker or satellite operator, signing contracts for the capacity, and arranging to have the right equipment furnished to effect transmission. This contrasts strikingly with the Internet's organic growth that has benefited from both an architecture that readily permits such organic growth and that thrives from the value of an extensively interconnected system (Moore's Law); even though specific instances of use of the Internet cannot individually begin to justify the existence of the system, each instant use has the potential to reach the entire network, and the cost justification of the network is distributed among the widest possible array of users. So the use of satellite broadcast systems can be anticipated to grow markedly by the present invention, because the present invention provides a method to enable a broad range of individual and instant uses of a satellite broadcast, communications and caching system that in aggregate justify a much expanded investment in satellite system infrastructure, and in which each instant use benefits from the potential to reach any part of the automated satellite, communication and cache system—where in advance of the present invention, satellite networks have been traditionally private, proprietary networks (that are individually cost-justified and provisioned).

Value of coordinated broadcasting and caching for popular and changing content that stresses and strains the infrastructure. In addition to the promising aspect of the present invention that enables broader and more efficiently shared use of satellite capacity, is the further promising—and complementary—attribute of coordinating the juxtaposition of information updating via satellite with local and distributed storing of the most current information on caches from which such current information may be locally retrieved. This can best be done in a novel way as detailed in the present invention, by a co-managed system, in which the automated negotiation and allocation is for both the broadcast satellite capacity and the local cache resources. The content most demanding to communication infrastructure is that content that is of interest to the greatest number of recipients and which changes with the greatest frequency. Such popular and variable content can leverage satellite's broadcasting efficiency for multiple simultaneous updating when the local storage caches are coordinated together with the satellite broadcasting updates. The presence of the caches demands just the type of intermittent use of satellite capacity that is not well accommodated in current systems. The introduction by the present invention of a co-managed satellite multicast and caching system with an automated negotiation and allocation system that enables anyone to compete via uniform rules for access to the system is a uniquely promising step forward for expanding the use and usefulness of satellites in the basic fabric of the Internet—a network that has grown because of the distribution, rather than centralization, of control.

Innovating a centralized tool via a decentralized implementation. The present invention provides a solution to the puzzle of distributing control and access to a centrally organized system such as a broadcast satellite.

Reliability, economy, and selectivity. Content management requirements commonly include broad but selective distribution of content through a reliable and extensive system with favorable economics. The requirement for favorable economics means that for popular content it is best to avoid transmission with unnecessary duplication on a distributed network (as is common when multicasting over the Internet), and that it is useful to leverage the economic efficiency of transmission via a satellite broadcast and caching system, in which such duplicative transmissions are minimized. The requirement for reliable distribution is only partly met by traditional TCP/IP networks, but is enhanced through efficient local caching and reliable satellite transmission. Selective distribution is made possible through the use of one of a number security, conditional access and encryption technologies in concert with the present invention.

Need for automated negotiation and allocation that handles contention. The present invention involves a system for automated negotiation and allocation of a satellite multicasting system that brings the aforementioned favorable attributes of satellites and satellite-linked caching systems to more efficient content distribution and Internet content staging. The present invention offers an innovative solution to the problem of contention for satellite capacity or other system resources that occurs when the supply of available system capacity does not meet demand. Traffic contention in the Internet results either in slowness (because of retransmissions) or even failed transmissions. An automated negotiation and allocation system such as discussed herein by providing clear procedures for cases of contention such as first offer or highest offer prevails enables not only a level of decentralized programmability useful to render the satellite multicasting system available to nearly any content contributor (in a manner somewhat parallel to the Internet decentralized programmability), but also offers the system operator to derive return more directly proportional to the value rendered to content contributors.

A variety of parameters for coordination, partitioning of resources and multiplexing of users' content. Another innovation of the present invention is the combination of automated negotiation and allocation for a plurality or types of content with a hierarchy of content descriptive parameters required to plan the organized partitioning of the resource consistent with an organized multiplexing of the content together on the resource. This permits specification of a range of attributes, such as: start time, duration, acceptable jitter, periodicity, number of instances, minimum bit rate, maximum bit rate, average bit rate, conditional minimum bit rate, conditional maximum bit rate, second, or third moments of the bit rate, other short-term statistics of the bit rate, acceptable probability of rate adaptation, decode buffer status, interest area, price to prospective content users or viewers, rules of access for prospective users or viewers, table of recipients, etc.

Auspicious present invention unmatched by current levels of automation of satellite systems. While there are rudimentary examples of sharing of a satellite system, none are known that involve coordinated satellite broadcasting and caching with automated negotiation for and allocation of access as in the present invention. The present invention promises to unlock satellites' multicasting capability for a system incorporating satellites, computers, and caches in an appropriately distributed fashion consistent with the decentralized architecture that has led to the strong growth of the Internet.

Computer automated negotiation for allocations within the satellite broadcast bitstream, and for space on system caches, allocation of both, and automated command to permit access. In a preferred embodiment, the present invention provides a system and method for automating negotiation for and allocation of a distributed and interlinked system involving satellites, caches, the Internet, and associated equipment. Additionally the present invention can interface with conditional access, billing, transactional or other system that can provide complimentary functionality for activities either begun or completed on the system. The present invention provides a reliable and efficient method for sending, receiving or storing of content or planning for the sending, receiving or storing of content, when that content is of interest to a number of different recipients.

Prospective users gain allocations through interaction with central rules process. In one embodiment of the present invention, interested content originators or destinations/viewers interact with a system manager according to rules defined by the system operator, stored and implemented in the system manager, and accessed by prospective system users. In such an example embodiment the rules may range from something as simple as first come, first served to highest bidder wins reservation and allocation of capacity with a wide range of possible variations. Various elements of the system resources (the origination sub-system, the satellite capacity, the receive and caching sub-system) are allocated according to the rules, their implementation, and execution in concert with elections of prospective system users. A number of possible objectives—market share, market segment, revenue, earnings, etc.—may influence the nature of the rules constructed. In order to be effective, the rules should be straightforward enough for prospective users to understand, and be well enough suited to the range of applications supported that system users find the system easy to use.

Method for allocation and associated transaction. Examples of rule components are auctions, time-period dependent rules, time varying conditional nullification of some rules (e.g., a certain level of bid will guarantee allocation without contention if committed by a certain time—a value that could be set somewhat above the predicted market level), options, variable-indexed offers, minimums, maximums, or other realizable construct. New rules may be even made subject to ratification by some threshold level of current users in a usage-weighted average or some other aggregation of preference. The goal of the rules is to provide an executable and sensible method of automating the provisioning and allocation of system capacity, and at the same time creating and recording a transaction involving payment or other consideration for the allocation or for related transactions.

Telemetered rules input. In order to effect the broadest possible range of rules, including where such rules may involve aspects of the size, scope, or configuration of the system or its users, the system manager is outfitted with the capability to receive timely updates of any such parameter to be used in the rules process, including by way of telemetering.

System manager command & control. After allocations have been made the system manager may provide command & control signals to each allocated system element to automate the provisioning of the allocation. Allocations to caches will be subject to additional constraints used to manage the cache resource that may be independent from the system manager process.

Cooperation with other systems. Reporting of transactions may be automatically coordinated with other systems, such as conditional access, automated crediting or debiting, or billing, which may be under common or separate control.

### BRIEF DESCRIPTION OF THE DRAWINGS

FIG. 1 is an overall system block diagram of a preferred embodiment of the present invention.

FIG. 2 illustrates an embodiment showing how rules are established and executed with negotiable offers to provision resources.

FIG. 3 illustrates an embodiment showing how individual offers are handled, so that system resources may be provisioned by rejecting, accepting or deferring offers.

FIG. 4 illustrates an embodiment showing how a content guide is distributed and constructed for planned provisioning of resources.

FIG. 5 illustrates an embodiment showing how caches may be provisioned by management using a cache-resident agent software program working cooperatively with the system and system manager.

### DETAILED DESCRIPTION OF THE INVENTION

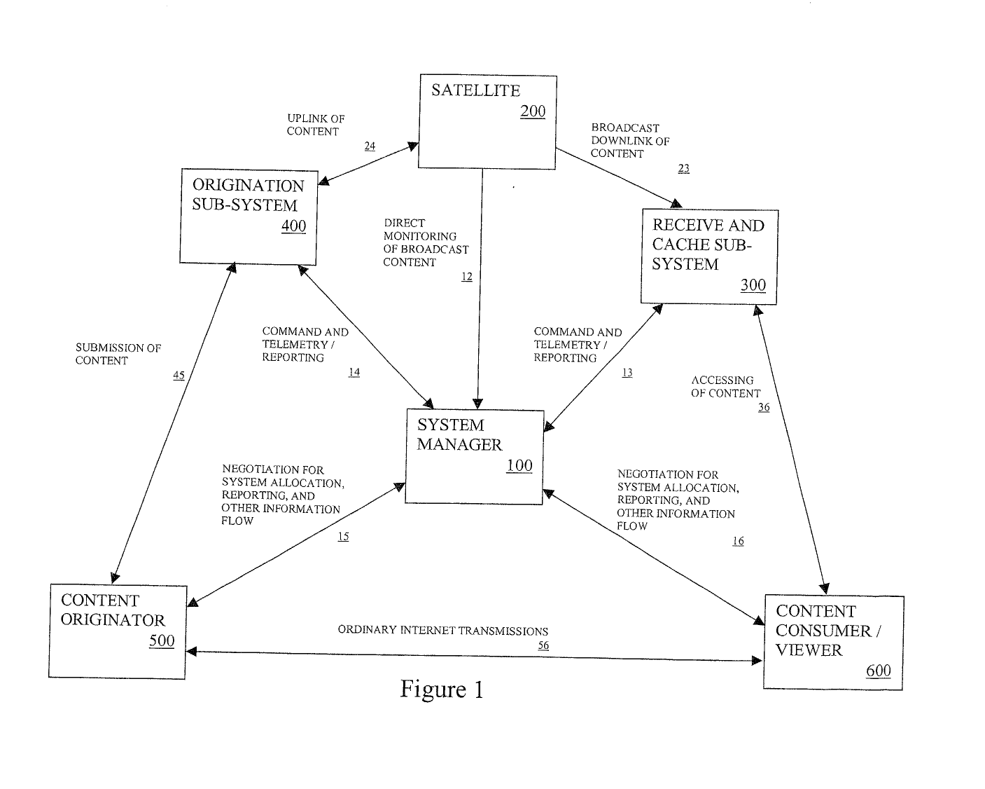

Referring now to the drawings, FIG. 1 illustrates one embodiment of the present invention.

As shown in FIG. 1, the present invention includes a system manager 100, satellite 200 (in another preferred embodiment, the satellite broadcast resource could be replaced by another type of communication, such as wireless transport, or storage resource), receive and cache sub-system 300 (in another preferred embodiment, the receive/cache sub-system could be replaced by another type of communication or storage resource), origination sub-system 400, content originator 500, and content consumer/viewer 600. The system operator, broker or rights-holder devises and implements rules for access to and use of the entire system that are stored and executed in a computer located in the system manager. The rules either incorporate a description of the system or a description of the system is kept current separately. Both the rules and description of the system and its status are made available to prospective users in the form of one or more guides either over the Internet or dedicated or dial-up or virtual data transmission circuits—in either case 15, and 16—or over the satellite system originating at the system manager 100, thence transmitted via the Internet or dedicated or dial-up or virtual data transmissions circuit 14, to the origination subsystem 400, thence transmitted via satellite uplink 24, to satellite 200, thence transmitted via satellite broadcast downlink 23, to receive and cache sub-system 300, thence retrieved via local high bandwidth or point-to-point transmission path 36, to content consumer/viewer 600, which may be collocated with the content originator 500. By organizing the system parameters (rules, system architecture, transmission or storage events, etc.) into distinct categories organized together in templates (that are used to create system guides), the system parameters may be efficiently and accurately passed through the system in a manner both intelligible to the system and users. A graphical user's interface, used as the user interface, provides graphical viewing of templates, or individual system parameters and other content, and elective options through the same graphical user interface.

Having current knowledge of certain aspects of the system 100, 200, 300, 400 500, 600, and rules for access in the system manager 100 (including a directory or guide of the current schedule status for confirmed and tentative content delivery or storage transactions 15) content originators 500, vie for access according to their objectives for using such a content distribution system by presenting offers 15 to the system manager, such offers 15 possibly incorporating other aspects of the system as variables, possibly including telemetered values representing current or historical system parameters—any or all of 12, 13, 14, 15, and/or 16. The rules execution in the system manager 100 proceeds with possible intermediate states reported—again any or all of 12, 13, 14, 15, and/or 16, according to which system element or prospective user should know such intermediate results. Once a successful offer is achieved by content originator 500 in a transaction confirmed by the system manager 100, the system may be accessed, content may be managed, and resources allocated. Content is sent from content originator 500 via the Internet or dedicated or dial-up or virtual data transmission circuit 45 to origination subsystem 400. According to elections by content originator 500 in concert with the system manager 100, and according to execution of the rules, the content is appropriately multiplexed with other content (possibly encrypted) and uplinked 24, to the satellite 200, thence transmitted via broadcast satellite downlink 32 to select receive and cache subsystems 300, according to prearranged preference (which selection may range from any interested receive and cache sub-system, to only those pre-selected by the content originator 500 or those that have met some other objective in the rules or matching the arrangement for the specific content delivery transaction). Records of transmission events, storage events, retrieval events and other transactions are kept and passed appropriately to cooperating systems, such as conditional access, billing, etc. according to the arranged transaction; including to enable automatic debiting or crediting of an electronic account.

The aggregate of confirmed future content transmission events as well as some tentative (not confirmed) events is communicated to prospective users of the system in a guide first originating at the system manager 100, thence transmitted via the Internet or dedicated or dial-up or virtual data transmissions circuit 14, to the origination subsystem 400, thence transmitted via satellite uplink 24, to satellite 200, thence transmitted via satellite broadcast downlink 23, to receive and cache sub-system 300, thence retrieved via local high bandwidth transmission path 36, to content consumer/viewer 600 (which, as before, may be collocated with content originator 500, or other location). Such a guide to confirmed and tentatively scheduled system programming enables preregistration, purchase or other offers or indication of interest 16 or 36 and 13 from prospective content consumer/viewers 600 that may be used in the execution of the rules (an example of one type of telemetry the system may employ), and permits prospective content consumer viewers 600 to review and select program options 36 to enable the receive and cache subsystem 300 to capture (possibly decrypt, encrypt, and/or re-encrypt) and store the content for subsequent access 36 by content consumer/viewer 600.

Multiple subsequent accesses of the content stored in the receive and cache subsystem 300 is to be managed both locally and systemwide according to elections of the system operator, users, and one of the rules based negotiations between them over the system, with reporting and account credit or payment management (e.g., credit incrementing and decrementing) both at the system manager 100 and at the receive and cache sub-system 300 coordinate with a cooperating conditional access and security system. When the rules are satisfied in the system manager 100, control signals are sent to the cache sub-system 300, to permit content access. Further access control may be implemented locally, included local control for accessing content up to a certain level of authorization, with higher level authorizations—such as periodic increases in access credits or content subscription elections—negotiated through the system manager 100, followed by the transmission of provisioning control signals from the system manager 100, to the receive and cache sub-system 300, or user 600, to provide authorization and any certificates or keys required to achieve such further access.

A centrally or locally controlled cached-content management algorithm may be administered in one of a number of predefined approaches, either directly by the system manager 100, or centrally via the system manager 100, with remote configuration by a designated representative for a specified group of receive and cache sub-systems 300, or autonomously by each receive and cache sub-system 300. Example algorithms for cache-management include: oldest content deleted as new space is required, least-used content deleted as new space is required, a target fill level is used that is less than the maximum capacity by a margin so as to increase the likelihood that no data is lost when the algorithm deletes old content as new content is admitted, future scheduled events are used to make projections of future cache status with alarm signals sent to entities that had requested any content that may be subject to deletion in order to increase the likelihood that unwanted data loss is avoided, different subsets of cache capacity may be administered separately (e.g., one part by the system manager, the complementary portion locally by a program in the receive/cache subsystem), including a variation where either the system manager or the local receive/cache subsystem-resident program can place overflow content in the portion of the system reserved by the other—subject to first deletion. Such cached-content management algorithms may prioritize content, notify administrators and certain users of certain events, actual or anticipated, including alarm conditions, aiming to provide minimal loss of content, and maximum utility of cache resources.

The system manager 100, may be a multiprocessor computer or multiple computers networked together, each managing a different aspect of the system management process—including the possibility that one of the networked computers is located remotely from the majority of the system manager 100 computers, such as at the origination sub-system 400 to focus on the management of content processes taking place at the origination sub-system 400. In this preferred embodiment, an agent program located at the content originator 500 continuously monitors the status of all of its past offers, and provides follow-up offers or revisions according to the goal of achieving an objective (such as securing the delivery of a file to a number of sites at minimal cost, with a cost trigger and/or system availability trigger at which a preemptive offer will be made to secure a capacity provisioning commitment). Administration of the agent program parameters and other content contributor elections are made using a graphical user interface at the content originator 500 or via application program interface links between the agent program and other programs.

In this preferred embodiment, the satellite 200, is shared by many content originators 500, and by many receive and cache sub-systems 300, by aggregating content on a single satellite accessed by all content originators 500, through the origination system 400, thus enabling all content from content originators 500, to be accessible by all content recipients (consumers/viewers) 600, through receive and cache-subsystems 300, according to exclusions that may be effected by the system manager 100, through the use of managed encryption. This permits the communications to pass in a controlled, but efficient way (for multicast data flows), to branch offices, customers, partners, suppliers, or even individuals at their homes (requiring in the lattermost case, a satellite receive and cache sub-system 300, to be located at the home).

A contract established between the system operator and content contributors sets forth a legal basis on which to establish rules within a range of variations that all are endorsed by both parties by way of the legal contract, so that system operation, including establishment of rules and use of the system according to those rules may proceed without reestablishing the legal basis every time rules are changed or new scenarios are presented.

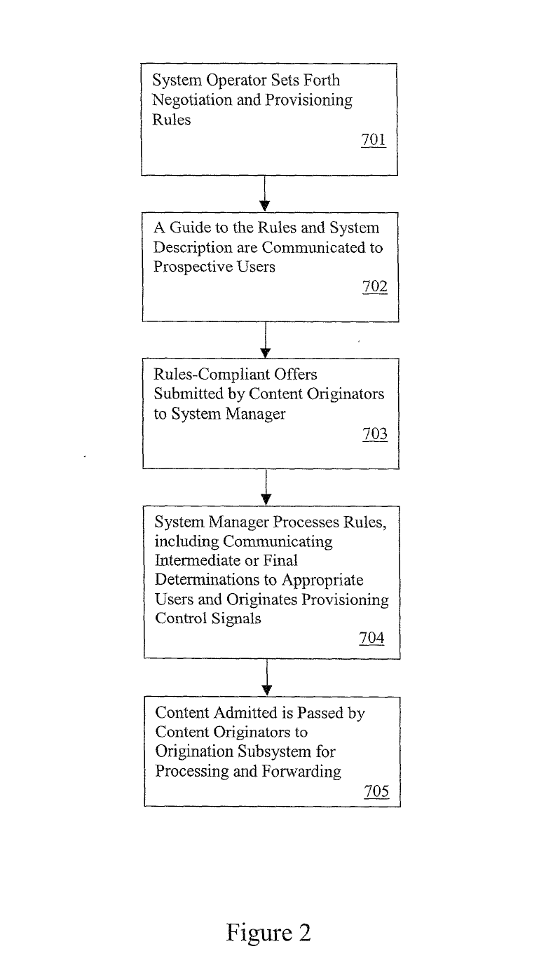

With respect to FIG. 2, a preferred embodiment of the process for negotiation of system capacity, provisioning of system resources and admittance of content is set forth. In step 701, the rules for both negotiation and provisioning are established. Such rules may take the form of mathematical algorithms, and/or step-by-step processes aiming to organize efficient, sustainable, and economically profitable utilization of system resources by permitting broad use of the system, including in cases of contention or when otherwise possible to provide preferential access to that user that offers a superior offer with respect to one or another rules-defined objective. In step 702, the rules and system description are communicated to prospective system users to inform them and to enable them to plan their use of the system, including offers to be submitted to the system manager for such use. In step 703, offers are submitted by prospective content originators to the system manager aiming to secure system resource allocations. As elsewhere defined herein, offers are formed in one of a number of predefined (template) formats. In step 704, offers are received and the rules are applied, with determinations (either intermediate or final) being made based on the rules (such as that further information is required, an offer is rejected, an offer is accepted, etc.), with such determinations being communicated to the appropriate user, and, as appropriate, control signals are originated to provision resources of the system. Successful offerors then submit content to the origination sub-system 400, in step 705, which processes the content for forwarding over the system.

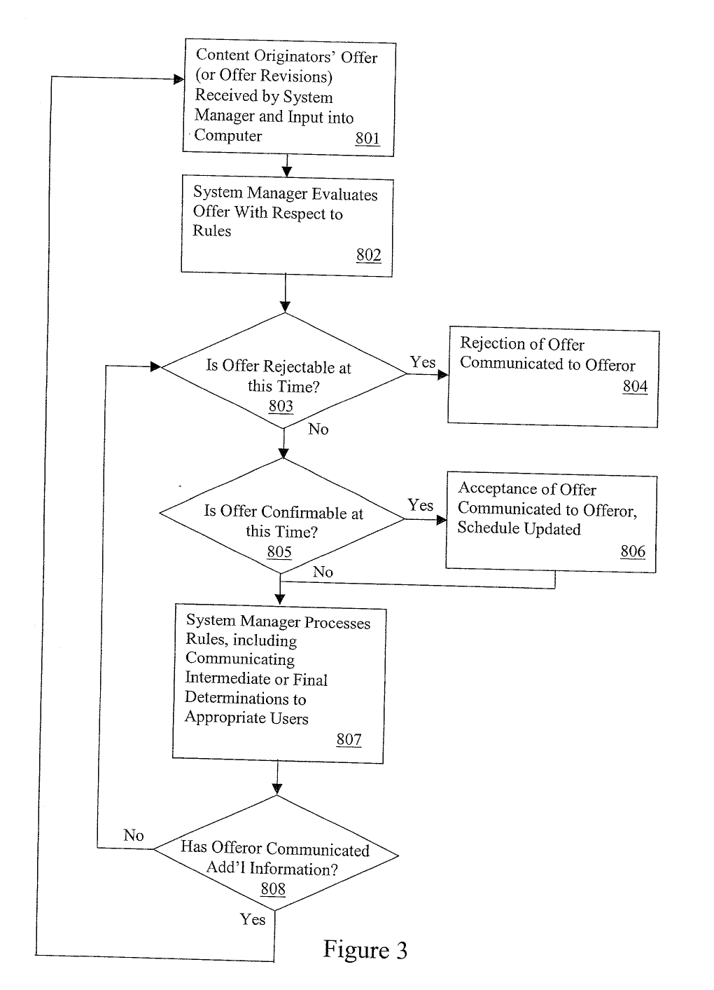

In FIG. 3, a preferred embodiment of the system manager process for reviewing offers is shown with respect to the rules and accepting or rejecting offers or providing intermediate determinations (which may be used by offerors to revise offers). In step 801, offers are received and input into the system. At step 802, the offer is reviewed according to the rules, current system resource availability, and other offers that may involve contention for common resources. At step 803, it is determined if the offer is not able to be accommodated and will not be able to be accommodated; if the offer cannot be accommodated and will not be able to be accommodated, it is rejected (804); if the opposite is true the process proceeds. At step 805, it is determined if the offer is able to be accommodated as is, in which case it is accepted, the acceptance is communicated to the offeror, and schedules and system status are updated (806). If the offer is not able to be confirmed, the process proceeds to step 807, wherein the system manager proceeds to make rules-based determinations and communicates them appropriately. Further processing at step 808, with regard to this offer then proceeds according to whether the offer provides additional information (in which case the process continues at step 801), or no additional information is provided by the offeror (in which case the process continues at step 803).

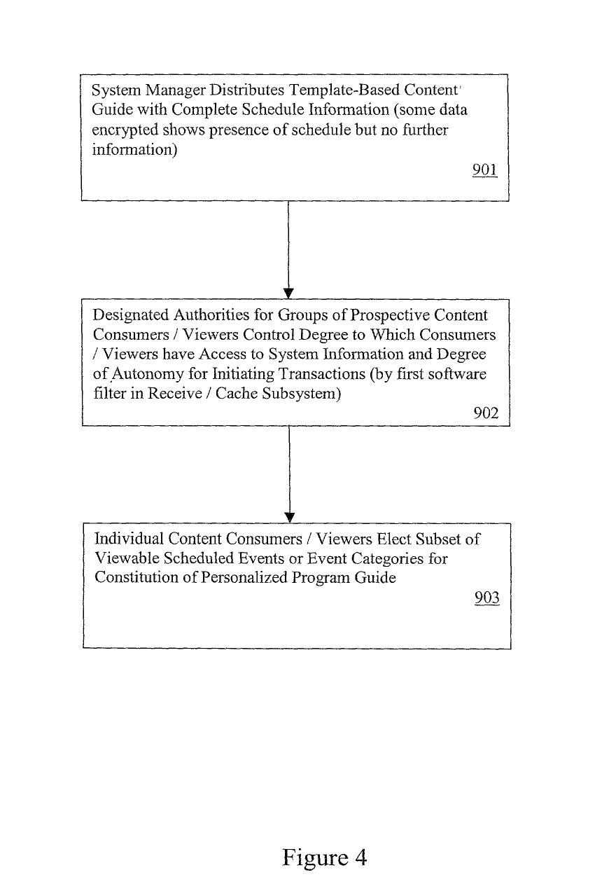

With respect to FIG. 4, a preferred embodiment of the construction of personalized viewer guides is shown. At step 901, the primary source of guide information, the system manager, constructs a guide (with appropriate permissioning or, alternatively, blocking of access according to any private content guide information) from the system manager, including a plurality of data describing what content will be available over the system in the future. At step 902, an optional group management functionality permits designated authorities over groups (e.g., the main office of a company may be designated to have authority in this regard over branch offices) to filter the content guide information available to members of a certain group (including the range of transaction options available locally by the content consumer/viewer). At step 903, individual elections may be made by an individual content consumer/viewer system to view only a subset of the guide, including, for example, prioritization or exclusion by event category.

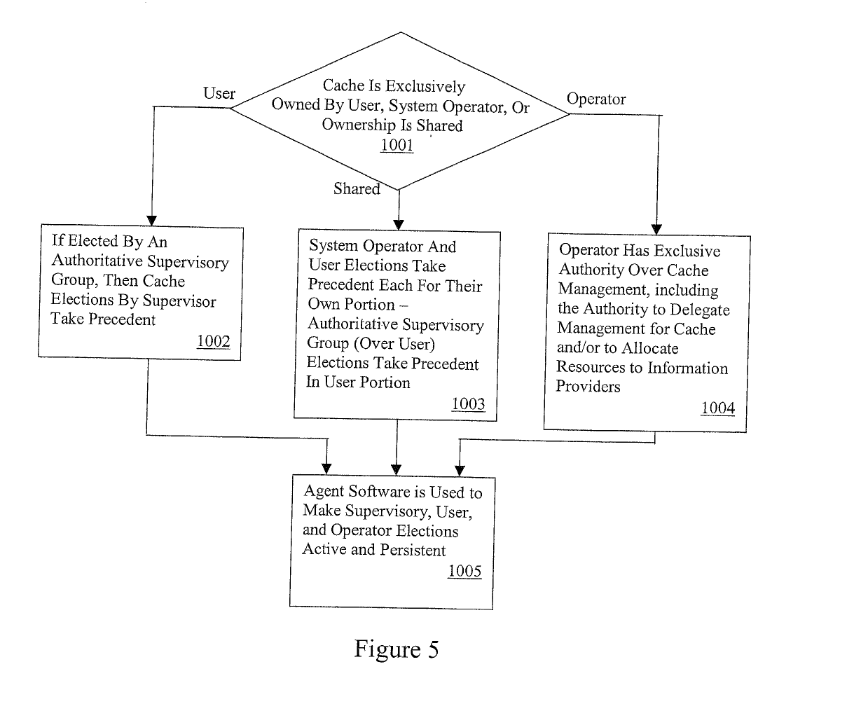

With respect to FIG. 5, a preferred embodiment of the process for managing the cache in the receive/cache subsystem is shown. In this preferred embodiment, at step 1001, the process branches to one of three subprocesses according to the status of cache ownership or control. At step 1002, if the cache ownership or control is exclusively by the user (the prospective recipient of system content) then only an optional supervisory level of control takes precedent over local control by an authorized local manager. The optional supervisory level permits a group of caches to be controlled by a remote manager authorized to configure and manage that group of caches (again, the example of a main company office maintaining the cache configuration and status for branch offices is a representative example of a designated authority for a group). Alternatively to step 1002, at step 1003, encountered when the cache is under common ownership or control by both the user and the system operator, to the proportionate degree that each holds ownership or to the degree that each has agreed to share control of the cache, each maintains the corresponding portion of the cache (including optionally interoperating to permit immediately preemptible use of the other party's cache portion), including the possibility of preferential supervisory control of the user portion by a designated group authority. In the third instance, and at step 1004, in which the cache is entirely owned or controlled by the system operator, the operator's authority is exclusive for cache management unless delegated to one or more third parties for a designated portion of the cache. At step 1005, and for each of the three other cases, it is contemplated that agent software will be used to effectuate elections, and to maintain the configuration of the cache, including managing inflow and outflow.

Exemplary Embodiments

In one embodiment of the present invention, the rules involve a first choice of immediately securing a confirmed allocation in exchange for a preset price or consideration, such price set to be at or above the anticipated market rate for that allocation. The alternative choice is to place an inquiry or offer; the inquiry indicating no commitment but the desire to be notified in the instance that another offer is placed that would preclude such an inquiry from being confirmed; and the offer indicating a conditional commitment that becomes a commitment to take the allocation upon 30 days in advance of the start time. The offer, while not being a confirmed offer will maintain preferred status for that allocation unless another offer of similar or higher status is subsequently placed (but before the 30 day in advance of start time window) that can not be simultaneously allocated—which event is called contention. In the event of contention, the higher status offer is maintained, the lower status offer challenged. Either offer may make subsequent offers either in response to the challenge or in anticipation of same. If either offeror submits an offer at the confirmable rate, then the other offer is abandoned with respect to that part of the offer that contended with the now confirmed offer. The remainder of the offer is also abandoned within a set time period unless the offeror elects to keep it, in which case it may be kept at the offered rate before the contention. A variation of this is to permit the purchase of an option for content delivery at a specified price (the price that would be required at the time the option is placed for acquiring committed capacity) and for a specified period of time (with the option priced commensurately) with the option fee to be paid even in the event of non-use, and that may either be subtracted from the applicable usage payment for content delivery services, or collected in addition to such usage payment in the event the option is exercised.

In this or another embodiment, the broadcast bitstream is partitioned according to a loading algorithm that aims to optimally schedule transmission events that aren't completely specified with regard to the time of transmission. This enables transmission requests that are between time A and time B to be scheduled at an optimum projected time between A and B for the system to carry maximum load. Another aspect of such a loading algorithm may be for conditional bit rate streaming signals that may have a conditional minimum bit rate required (i.e., whenever the signal bit rate is above this conditional minimum, it should never be reduced below the conditional minimum, but may be reduced to the conditional minimum according to some worst case loading scenarios) to be multiplexed according to a rate adaption transcoding permitting a more efficient loading of the system in exchange for such incidental conditional bit rate adaptation of streaming signals that can accept such rate reductions.

In another preferred embodiment, the rules incorporate a bidding process for accessing satellite multicast capacity based upon a per unit offered price for satellite bandwidth together with the number of recipients, either maximizing an objective of the product of the two factors or, to place greater emphasis on (and preference to) the number of recipients, an objective such as the square of the number of recipients multiplied by the per unit offered price. In a variation, recipients may be replaced by receivers in the rules for accessing the satellite multicast resource. Together with this or another preferred embodiment, content is encrypted in two successive stages, first over the satellite broadcast link 24 and 23, and then in the successive link 36 for access by content recipients over a LAN as they access desired content from the receive and cache subsystem. Such encryption may be used to limit the access to only those who have fulfilled certain requirements (paid for the content, completed prerequisite training, not viewed the content before, expressed interest in a particular product or service, etc.).

these or another exemplary embodiment, the range of parameters that may be used for the rules, templates, and guides, includes temporal parameters (used for determination of availability in the time dimension together with other variables, and used for scheduling of resources upon completion of negotiation) such as start time, duration, acceptable jitter, periodicity, number of instances; rate parameters (used for determination of availability in the bandwidth, or bit rate dimension together with other variables, and used for scheduling of resources upon completion of negotiation) such as minimum bit rate, maximum bit rate, average bit rate, conditional minimum bit rate, conditional maximum bit rate, certain moments of the bit rate, periodic instances of the bit rate, acceptable probability of rate adaptation, decode buffer status; volume of data (used especially for opportunistic data to confirm availability and perform scheduling); interest area (to categorize for guide presentation purposes); price to be offered to prospective content recipients (that may be used together with an estimated number of recipients, and a share to be retained by the system operator, in one of the automated negotiation processes for capacity, or for control of content retailing, including presentation in a content guide, as well as collection, conditional access, and decryption to permit access).

Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art.

What is claimed is:

1. An automated negotiation and provisioning method for broadcast or other communication or storage resources or a system incorporating such resources, in which content is admitted to the individual resources or system, and/or managed within the system via an automated negotiation and provisioning system manager (computer) that allocates resources or directs system operation, comprising the iterated steps of:
inputting into a computer the rules for admission to and/or use of the resources and/or system,
outputting from the computer a summary of the rules,
inputting into the computer offered terms for admission or use by prospective users of the resource or system,
outputting from the computer intermediate determinations and/or final binding terms for successful offers.

2. The method of claim 1, with an additional iterated step of:
outputting from the computer command signals to resource or system controllers or other system elements that reflect binding determinations from the automated negotiation and allocation process.

3. The method of claim 1, with an additional iterated step of:
inputting into the computer telemetry (or other automated or manual observations) to be used in the rules.

4. The method of claim 1, in which the resource or system of resources includes a geo-synchronous satellite.

5. The method of claim 1, in which the resource or system of resources includes a terrestrial-based wireless transport.

6. The method of claim 1, in which some of the content admitted to the system or controlled by the system is encrypted in order to permit selective access to the content solely by one or another subset of system receivers intended to receive that content.

7. The method of claim 1, in which a parameter representing some number of real or hypothetical receivers is used in the rules.

8. The method of claim 1, in which a guide is used to simplify identification of content traversing the resource or system of resources, such guide providing custom-tailored views of content schedules or repositories permissible to be viewed by a given viewer and either communicated over the resource, system resources, or the Internet (or alternative dedicated or dial-up or virtual data transmission circuits).

9. The method of claim 1, in which a guide is used to communicate the status of the rules-based procedure including showing availability of capacity and status of resources and negotiations, such guide being communicated over the resource, system resources, or the Internet (or alternative dedicated or dial-up or virtual data transmission circuits) to system users.

10. The method of claim 1, in which the content, terms of offers, and other aspects of resource and/or system operation are categorized for rules-processing, allocation, control, and guide purposes according to sets of parameters associated with a plurality of templates, each template including a certain set of parameters.

11. The method of claim 10, in which the parameters include one or more of the following:
temporal parameters,
start time,
duration,
maximum acceptable jitter,
periodicity,
number of instances,
rate parameters,
minimum bit rate,
maximum bit rate,
average bit rate,
conditional minimum bit rate,
conditional maximum bit rate,
second, or third moments of the bit rate,
periodic first, second, or third moments of the bit rate,
acceptable probability of rate adaptation,
decode buffer status,
volume of data,
interest area,
price to prospective content users or viewers, and
other rules of access for prospective users or viewers.

12. The method of claim 1, in which a cache is used to selectively store content received over a broadcast or communication system resource.

13. The method of claim 12, in which the content admitted to the cache is decrypted (if it had been encrypted) and then re-encrypted (or encrypted for the first time) for controlling access of the content as it is used from the cache.

14. The method of claim 12, in which the cache is positioned directly downstream of a broadcast receiver and positioned directly downstream of the cache is a high-bandwidth localized computer network.

15. The method of claim 1, in which the inputting and outputting take place on different computers connected via a network.

16. The method of claim 1, in which the inputs derive from either real-time elections or agent-actuated elections according to preset condition-based elections.

17. The method of claim 1, in which some or all of the steps are recorded and reported to cooperative billing, conditional access, or other cooperative process or system.

18. The method of claim 1, in which a transaction is effected either creating automatic charges or debits to an account or initiating an instant transfer of funds.

19. A method for aggregating system users into a communications neighborhood, community, or other focal area comprising:
using multiple access sharing techniques (such as TDMA, SDMA, CDMA, FDMA, a combination thereof, or other multiple access technique) for sharing a communications channel;
in which the communications channel provides connectivity to a plurality of receivers, each of which may use the communications channel for internal communication, communication with partners, communication with suppliers, communication with customers, or other entity.

20. The method of claim 1, in which the rules for admission or control aim to maximize some objective, such as:
the unit price for some commodity measure,
the total number of users, or
total revenue.

21. The method of claim 1, in which the rules involve one of a number of auction structures, such as:
sealed bid auction,
first price auction,
discriminatory auction,
second price auction (Vickrey auction),
uniform price auction,
open bid auction,
English auction,
Dutch auction,
all-pay auction, or
common value auction.

22. The method of claim 1, in which the rules involve one of a number of options structures.

23. The method of claim 1, in which the rules are specific with regard to the time period during which offers may be input, and the inputting of offered terms is during that time period.

24. The method of claim 1, in which the rules are specific with regard to the time period during which delivery, control, and/or storage would take place, and the outputted control signals correspond to that time period.

25. The method of claim 1, in which the rules involve successive stages each involving one or more of the methods herein described, each method used either independently or in combination with other methods, where successive stages are begun or ended by rules-based determinations of the method of claim 1.

26. The method of claim 1, in which subscribers, content recipients, viewers, other system users or prospective users provide information to the computer regarding changes in subscription status, election of pay-per-view event options, viewing of a given content segment, or other feedback or interactive message to be used in the method of claim 1, and also in associated reporting and billing processes.

27. The method of claim 1, in which a graphical user interface is used as the remote client interface for the entity (or entities) seeking to effect content delivery, control, or storage, where the graphical user interface is linked to the computer via the Internet or dedicated or dial-up or virtual data transmission circuits, and where the remote client interface is automated with a software agent acting as a proxy for the remote entity.

28. The method of claim 1, in which a contract is established between parties in advance of enactment of their respective roles for any implementation of the method of claim 1, said contract establishing the legal basis for the procedures of such an implementation of the method of claim 1.
